(19) United States
(12) Patent Application Publication
(10) Pub. No.: US 2026/0099777 A1
(43) Pub. Date: Apr. 9, 2026

(54) SYSTEMS AND METHODS FOR DYNAMIC AUGMENTED BACKEND DATA STRUCTURE REPRESENTATION FOR COMBINING CONTRACTED INVENTORY AND OPEN BLOCK INVENTORY

(71) Applicant: STREAMPOINT SOLUTIONS INC., Toronto (CA)

(72) Inventors: Avraam ZOSIMADIS, Toronto (CA); Dharmesh DAYABHAI, Toronto (CA); Jonathan BRUCE, Toronto (CA); Peter SYMANIW, Stoney Creek (CA); Jan Gabriel ONA, Toronto (CA); Paul Andrew BIRKBECK, Toronto (CA)

(21) Appl. No.: 19/351,268

(22) Filed: Oct. 6, 2025

Related U.S. Application Data
(60) Provisional application No. 63/704,016, filed on Oct. 6, 2024.

(51) Int. Cl. G06Q 10/02; G06Q 30/0283

(52) U.S. Cl. CPC G06Q 10/0285; G06Q 30/0283

(57) ABSTRACT

A technical challenge with open block inventory is that there is open competition and a level of uncertainty as to whether a room is actually available for booking at a particular price. A race condition can arise when multiple parties are interested in a same booking at the same time. An improved dynamic augmented backend data structure representation for combining contracted inventory and open block inventory is proposed for more efficient computer representation and interactions thereof of the heterogenous inventory. The heterogeneous data objects can be stored on a database table that is extended with additional columns and fields to represent a greater entropy level associated with open block inventory.

### CROSS-REFERENCE

This application is a non-provisional of, and claims all benefit, including priority from, US Application No. 63/704016, filed 6, Oct. 2024, entitled SYSTEMS AND METHODS FOR DYNAMIC AUGMENTED BACKEND DATA STRUCTURE REPRESENTATION FOR COMBINING CONTRACTED INVENTORY AND OPEN BLOCK INVENTORY.

This document is incorporated herein by reference in its entirety.

### FIELD

Embodiments of the present disclosure relate to the field of machine learning and data structures, and more specifically, embodiments relate to systems and methods for dynamic augmented backend data structure representation for combining contracted inventory and open block inventory, the dynamic augmented backend data structure representation including time-based and probabilistic data fields.

### INTRODUCTION

Managing heterogeneous data objects is a technical challenge that arises in respect of coordination middleware platforms that support registration and reservation process front-ends. In particular, the coordination middleware platforms utilize sophisticated computing backend systems that are adapted to handle a large scale of simultaneous instances who are competing for a limited resources that can be interacted with through application programming interfaces. Contracted inventory (e.g., rooms that are contracted by a particular entity for a particular event), from a computational representation perspective, can be considered as a more stable type of data object. On the other hand, open block inventory (non contracted inventory) is available for booking on an on-demand basis. Combining these two heterogeneous data objects is a non-trivial technical challenge. Although inventory can be gauged at a particular point in time, there is a period of time that elapses between booking and inventory observation, and the inventory may have changed characteristics or may no longer be available.

### SUMMARY

A technical challenge with open block inventory is that there is open competition and a level of uncertainty as to whether a room is actually available for booking at a particular price, particular location, particular hotel and particular room type. A race condition can arise when multiple parties are interested in a same booking at the same time. An improved dynamic augmented backend data structure representation for combining contracted inventory and open block inventory is proposed for more efficient computer representation and interactions thereof of the heterogenous inventory. The data structure is augmented using machine learning to add time-varying learnable factors that are then used to generate a more accurate graphical user interface rendering.

The heterogeneous data objects are stored on an augmented database table that is extended with additional columns and fields to represent a greater entropy level associated with open block inventory. The database table is a dynamic augmented backend data structure representation including time-based and probabilistic data fields that represent monitored or estimated entropy levels associated with the open block inventory, and in some embodiments, the system is configured to automatically generate and issue booking reservation data messages using various booking parameters to opportunistically hold space based on an estimated requirement. In some embodiments, the system is configured to automatically identify booking and cancellation processes through automated website crawls or interface queries, and the system updates a backend model corresponding to transient availability.

Monitored interaction data with the platform is utilized to modify adjustment factors that are associated with the monitored or estimated entropy levels to provide a second input that is indicative of potential velocity of bookings and potential user behavior. Interactions are anonymized and vectorized to train a machine learning model as aggregate data sets. The anonymization and vectorization assists with establishing improved privacy between different unaffiliated users of a platform, and the approach adheres to local privacy laws. In some embodiments, consent is obtained from users who permit their interaction behavior to improve the accuracy of the machine learning backend system. The second input can be used to determine, for example, a demand surge velocity value based on the tracked user behavior of other users, converted into vector form.

Where availability is transient and may vary depending on booking volumes of supply and demand, the dynamic augmented backend data structure representation includes time-based and probabilistic data fields that are periodically updated and modified based on time-based delay and updates in probability of availability.

The dynamic augmented backend data structure representation is updated through periodic polling, and the input data sets from a crawler are provided to a backend machine learning model, which is configured to periodically update the time-based and probabilistic data fields with estimated logit values obtained from operating the backend machine learning model in an inference mode.

The backend system can be configured to expose the combined data table on a graphical user interface so that a hybrid representation for combining contracted inventory and open block inventory to show a greater availability and flexibility of reservations.

Upon receiving a booking request, the system is configured to interrogate the combined data table to route data messages accordingly to generate a hybrid booking utilizing a combination of contract block inventory and open block inventory. When generating a hybrid booking, the time-based and probabilistic data fields are utilized to determine whether the system will automatically make opportunistic reservation messages, which in some cases can include a combination of refundable, semi-refundable, or non-refundable bookings, depending on the system's expected demand for the hybrid booking, for example, which can be based on a determined velocity of booking confirmations and/or cancellations.

The time-based fields are automatically updated using the machine learning model, which imparts a machine learning based time-decay factor and adjustment to more accurately gauge time-based signals in booking/availability behavior. Open block reservations are automatically made and cancelled to hold availability by the system, and in some embodiments, the system is able to determine equivalent bookings to provide alternative bookings in the event that availability is no longer available.

In some embodiments, the system is configured to utilize booking APIs or other mechanisms to keep rooms open for a period of time so they can be put in the system in a form similar to contracted inventory.

In another embodiment, the system is configured to poll/probe APIs to try to accurately gauge inventory and availability, and measure trends to predict whether a possible reservation is available.

The system is practically implemented either as a monolithic system or a number of microservices that communicate via remote procedure calls (RPC) and queues. The system can include a special purpose machine operating as a computer server or a connected set of computer servers, and an interface can be hosted behind a web API, providing a backend computing platform coupled to a user interface that renders visual interface elements that is usable for generating and tracking bookings.

As described herein, the backend computing platform is configured for automatic aggregation of multiple room sources (in or out of block) to assemble reservations from a multitude of sources, and an improved reservation aggregator engine is proposed that is configured to utilize a variety of data points to first establish equivalency through machine generated estimations, and potentially pre-purchase rooms at lower costs (hotels may modify prices as rooms fill up).

In some embodiments, the system is configured to access datasets representing events currently in the pipeline and their estimated attendance, currently available inventories and the current sales uptake (how inventories for the required days has decreased recently), historical seasonal trends and world events. All of this information in the input data sets can be used to both train and utilize for inference a machine-learning model that is configured to predict which rooms the system can book in advance, and the outputs can be used as output logits for generating one or more pre-bookings or hold requests. As there can be different hold and cancellation options available through the APIs, the system can automatically be configured to operate as an agentic pre-booking engine to opportunistically establish holds and cancellable reservations in an effort to reduce overall costs.

The model is periodically retrained using current data and the system is configured to retrain the machine learning model such that the system is able to automatically adjust and optimize based on incoming data. A graphical user interface interacts with the back end via a web API and can be implemented, for example, as an SPA (single page application). The room block store and associated extended metadata can be stored in a relational database, for example, with extended metadata fields and tags for improved computing fields pre-determined and calculated for the decision support interface.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a block schematic diagram of an example system for combining heterogenous data objects into an augmented data structure representation, according to some embodiments.

FIG. 2 is a block schematic diagram of an example system for combining heterogenous data objects into an augmented data structure representation, according to some embodiments.

FIG. 3 is a data process diagram showing the data management rules and data flow within the system, according to some embodiments.

FIG. 4 is a user interface diagram on an output display of a user device which displays an exemplar augmented data structure representation.

FIG. 5 is a schematic diagram of a computing device such as a server, according to some embodiments.

FIG. 6 is a block schematic diagram of an example system architecture for combining in block and out of block inventory and corresponding adapters, according to some embodiments.

FIG. 7 is an example machine learning backend configured to support the system shown in FIG. 6, according to some embodiments.

FIG. 8 is an example interface showing a dynamically generated decision support interface with intermingled contracted block and open block inventory interactive graphical data objects, according to some embodiments.

### DETAILED DESCRIPTION

A technical challenge with open block inventory is that there is open competition and a level of uncertainty as to whether a room is actually available for booking at a particular price, particular location, particular hotel and particular room type. Essentially, a race condition can arise when multiple parties are interested in a same booking at the same time. An improved dynamic augmented backend data structure representation for combining contracted inventory and open block inventory is proposed for more efficient computer representation and interactions thereof of the heterogenous inventory. The heterogeneous data objects can be stored on a common database table that is extended with additional columns and fields to represent a greater entropy level associated with open block inventory. Increased estimation accuracy allows the system to provide an improved decision support interface using dynamically adjusted parameters.

A practical situation that can occur is where an event coordinator's limited inventory of static contracted reservations is no longer sufficient for an event. In this situation, users may seek alternative, non-static contracted options for reservations, and may otherwise seek to use external platforms to book these options. However, by using external platforms, the user may become disconnected from a curated event experience or common user interface of a platform associated with the event.

As described herein in further detail, an improved platform is proposed that provides a combined view of heterogeneous contracted reservation inventory along with open block inventory. From a back-end perspective, innovative data structures and machine learning models are used to support the updating of probabilistic data fields that are used to append data fields to the open block inventory elements to reflect entropy and uncertainty associated with the open block inventory elements.

Accordingly, from a front-end perspective, open block inventory interface elements and indications are provided alongside contracted inventory as equivalent booking options, and the user may interact through a graphical user interface to access and make both contracted and open-block reservations (e.g., selecting room types, rates, using an interactive map with detailed hotel views, eliminating the need to navigate external booking sites). Each booking is tied to the event, simplifying audits and ensuring precise tracking, as open block inventory and corresponding bookings are directly connected and managed as part of the associated event data. As the open block inventory is not always available, the system is configured to modify and constrain the inventory based on machine learning outputs to add a time-varying factor in the generated visual interface elements, based on logit outputs from a machine learning model optimized using a loss function for accuracy relative to a training set of known labels from previous booking attempts. An ongoing corpus of data can be obtained and used for retraining to improve the accuracy of the system.

Contracted inventory can be easily held and managed within a platform as it is a fixed object that has static availability and price since it is not impacted by external/third party actors. Contracted inventory can include confirmed reservations for a specified number of rooms or guests. Contracted inventory can be represented as statically available inventory that will be available in the backend data structure. Under contracted inventory, an administrative user can enter a contract to block off a pre-determined quantity of inventory which is then held within a listing which is linked to the platform within a global distribution system. Open block inventory on the other hand is a dynamic inventory in which availability and price may change within a short time-frame. The open block inventory can be interacted with through an API, and periodically polled to obtain one or more datasets indicating the amount of current inventory, the latest prices, and booking options (e.g., refundable, non-refundable, refundable after a certain date).

The dynamic nature of open block inventory causes potential issues where a user may attempt to book an open block object which is no longer available on the third party server. Due to the heterogenous characteristics of contracted and open block inventory, they are kept separate such that contracted inventory is available within the internal platform and then a third party site is integrated such that overflow bookings (i.e., once contracted rooms are filled) are directed to the third party site and away from the internal platform. This can negatively impact user experience and realisation for event organizers. A challenge with open block inventory is that the data records being maintained may quickly become stale and phantom availability and pricing is possible, especially during periods of high volatility, or demand. Conversely, availability can increase in response to changes in environmental conditions, such as a concert or an event being cancelled due to a performer's scheduling changes.

Inventory, for example, can be obtained from a partner API that provides programmatic access to property performance data, listing characteristics, listing availability, pricing, and these can be returned responsive to query messages. For example, a partner API may be used to obtain current availability of various rooms and booking options. For each available room or room type, the API, once queried, may make available a time-stamped XML file corresponding to the characteristics of that particular room or room type, and the corresponding price, as well as any promotions, rate modifications, optional charges, among others. It is important to note that the time-stamped XML file that is generated in response can become stale as there are dynamic changes in availability. Accordingly, a same room or room type may be re-priced as rooms become less available. In areas with limited inventory or durations of time where there are multiple large events taking place, the stale-ness of inventory can occur quickly.

The proposed system and method provides the ability to combine the heterogenous data objects of contracted and open block rooms into a single augmented data structure which can be presented to a user in a seamless interaction. Effectively, open block and contracted inventory can be shown together as “inline bookings”. The platform contains a set of APIs which communicate with a global distribution system that contains available contracted and open block inventory. The global distribution system is configured to operate with third party servers to pull contracted and open block inventory into a single environment by periodically polling APIs to obtain inventory information at various points in time. The proposed system extends data objects corresponding to each room type with additional machine learning based adjustment field variables, as described herein such that the system is able to show availability that is a combination of the contracted and open block rooms, and constrain the availability based on machine learning based time parameters. The machine learning based adjustment field variables are used to establish estimated equivalency with static availability of contracted inventory such that all of these options can be provided together in a decision support interface. Machine learning provides a non-deterministic approach for estimating non-linear relationships between environmental data to provide a proxy mechanism for accurately estimating diminished availability through observations in a corpus of data. These proxy mechanisms are then appended to a data structure and used at run-time to generate the updated graphical interface elements to indicate the estimated constrained inventory of open block available reservations.

The contracted and open block inventory is stored within a non-transient memory which structures the heterogenous data objects within a data table which is expandable in order to compensate for the dynamic characteristics of open block inventory. The data table provides an augmented data structure which is composed of a single storage format so that a user can seamlessly view available inventory within one platform, regardless of whether it was contracted or open block. The dynamic augmented backend data structure representation includes time-based and probabilistic data fields, as well as trainable data fields that are used to represent data elements.

The dynamic augmented backend data structure representation is used to establish equivalency with static contracted block inventory such that the graphical user interface and reservation system is able to provide a consolidated view to users based on a computer generated estimation of real availability and pricing based on machine learning based automatic adjustments, providing an improved decision support interface for users.

The automatic modifications on the backend are conducted periodically to optimize the adjustment factors such that the adjustment accuracy is improved over time. In some embodiments, platform usage of the system is also utilized as an adjustment factor in determining equivalency. The machine learning model and time-decay based probabilistic approaches are utilized to account for both a staleness since the time-stamped poll data, as well as potential decay speed due to environmental factors, automatically accounting for surges in demand or changes in availability using the machine learning generated time-decay value as a proxy.

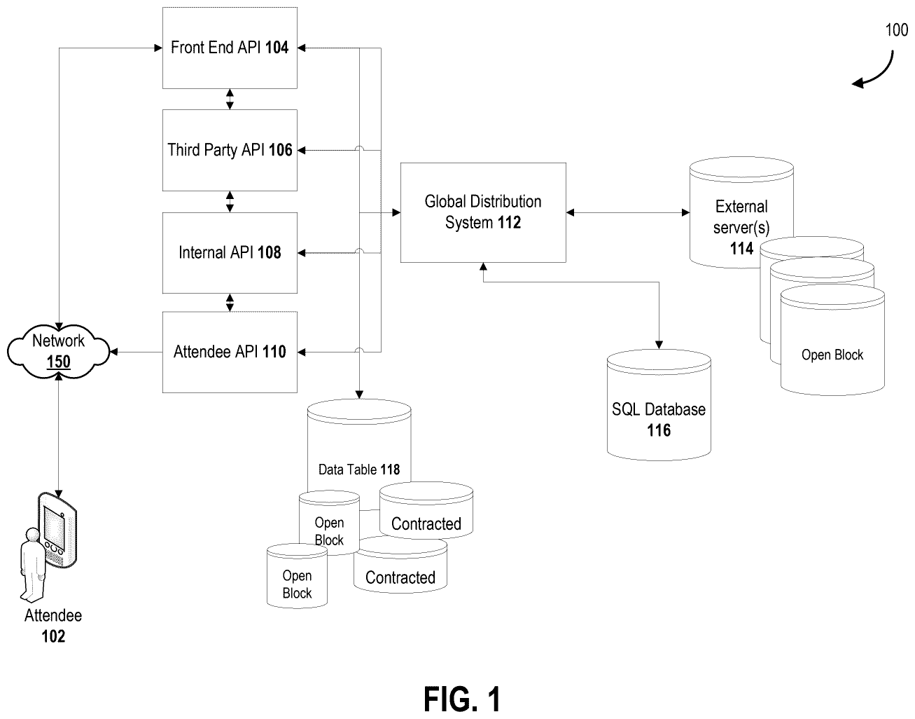

FIG. 1 is a block schematic diagram of an example system 100 for combining heterogenous data objects into an augmented data structure representation. System 100 may include one or more processors coupled with one or more memory devices. System 100 may be connected to a cloud based network 150 in some embodiments.

System 100 may be used for event management such that an administrator may make a block booking composed of a pre-determined number of contracted rooms which are reserved for attendees of an event. For example, a conference host may book a hundred contracted rooms for attendees to ensure that all attendees will be housed within the same hotel near the conference location. However, it is difficult for an administrator to know exactly how many attendees will be attending their event, and therefore there is a risk that more attendees will seek housing than there are contracted rooms. Alternatively, there is a risk that attendees will only be able to book a portion of their trip within the contracted inventory, and the remainder of their trip will have to be through open block (i.e., non-contracted) inventory.

In this situation, an administrator may wish to ensure that attendees can still book housing which is identical/similar to the contracted rooms. This will require the platform to provide a seamless combination of contracted and open block inventory (“inline bookings”) to an attendee who can select the necessary booking options without having to leave the platform to find available inventory on third party servers. As described herein, a problem with open block inventory is that the inventory is not always truly available, and there are issues with fluctuating prices and availability that cause a level of inaccuracy or staleness in booking.

When trying to submit a booking request through an API, for example, the prices may no longer be accurate and/or the booking may simply be refused due to changes in availability. A danger of providing inline bookings through a computing interface is that it is desirable to avoid a situation where the interface shows an unrealistic availability due to stale availability estimations from polled data from external APIs.

Being able to identify or estimate changes in availability is very important, as there are impacts on user experience as well as platform stability. As described herein, system 100 is configured for maintaining an additional backend data structure that is extended to include specific probabilistic and time-decay metadata fields to provide an improved decision making interface for users when the users are assessing the availability of inventory in the system, whether the inventory is contracted blocks or open blocks.

The system is designed to automatically constrain how much inventory is shown in the graphical user interface in an attempt to provide a more realistic view. Further, in a further variant embodiment, the system can also be designed to automatically attempt to replenish or add reservations or reservation holds into a contracted block if contracted block inventory has fallen below a particular amount in an attempt to automatically and opportunistically hold a particular price level. For example, the automatic reservations can occur during a time period where contracted rooms have been all booked far in advance of a booking date, the automatic reservations being triggered to establish some level of availability up to a particular cut-off period prior to the event date (to avoid the system booking rooms that cannot be filled).

The probabilistic and time-decay metadata fields are adjusted parameters that include a training factor obtained through monitoring platform usage and/or periodic polling data from the booking APIs such that the adjustments can be made based on observations taken across a period of time. In some embodiments, the adjusted parameters are adjusted based on a machine learning model that is maintained separately on the backend that is trained based on tracked interactions on the platform as well as the periodic polling data from the booking APIs. The machine learning model outputs a series of adjustment logits that are then utilized by the decision making interface when generating visual interface elements for the user.

In one example of system 100, an administrator may set up an event offering within the platform housing system 100. The administrator may have 100 contracted rooms which are available through the platform, and may also set certain logic conditions which control the conditions on when open block inventory is offered to attendees who are seeking accommodations.

Under the system 100, a front end API 104 is configured to receive a booking query from an attendee 102 who may wish to make a reservation under a specific event being hosted by an administrator. The booking query may be communicated from a user device to the front end API 104. The booking query may not specify whether the attendee 102 would like to book contracted or open block room inventory, and therefore the logical conditions set by the administrator will determine what is presented to the attendee 102.

The front end API 104 may be configured to parse the booking query and identify, through metadata embedded within the request, the event and contracted inventory block which the request is associated with. The front end API 104 may transfer this information to the third party API 106, the third party API 106 being configured to submit pull requests to a global distribution system (GDS) 112 for open block inventory availability which corresponds to the metadata embedded within the request.

The GDS 112 may be configured to generate for the third party API 106 a dynamic listing of open block inventory which satisfies the initial attendee request. The open block inventory availability is pulled from third party servers 114 and therefore the listing does not have a stable structure since objects can change in terms of availability and/or cost. Further, since the open block inventory is brought in from third party servers, the data structures may differ compared to other open block inventory and the contracted inventory which is also associated with the user request.

In some embodiments, the GDS 112 may pull open block inventory from third party servers 114 which have been identified by the administrator to match contracted inventory already associated with the event. In some embodiments, the GDS 112 may use metadata obtained from the user request when generating the open-block inventory availability which is stored in the data table 118. Since the user request is associated with an event organized by an administrator, the attendee request will include metadata related to the associated event which will also be used by the GDS 112 when generating open block inventory availability.

Metadata used by the GDS 112 may include context specific data such as the cost an attendee would like to spend on inventory, location of event, dates of event, duration of stay, type of inventory, accommodation rankings, discounts available, other preferences set by the administrator when making the booking contract.

Once the open block inventory is pulled from the GDS 112, the internal API 108 is configured to compile the contracted inventory associated with the user request. The contracted inventory is stored within the platform as it has already been put on a hold due to the contract entered into by the administrator. The compiled contracted inventory is transferred to a non-transitory memory storing a data table 118 which is configured for storing heterogenous data objects.

Data table 118 receives both the contracted inventory and open block inventory as heterogenous data structures. These can include individual XML files that are loaded into the data table 118. The data table 118 is configured to be extendable with additional metadata fields so that the data table 118 can capture the unstable nature of the open block inventory data objects which were pulled from the GDS 112.

The system functions to parse the contracted and open block inventory into a single storage format stored in data table 118 such that an augmented data structure is generated. In some embodiments, the metadata fields also include machine learning estimated adjustment factors that are used for dynamic rendering of the graphical user interface elements. For example, there may be fifty contracted block rooms, as well as seemingly one hundred and eighty available open block rooms at different price points. However, the system is configured to modify the rendering of the availability of the open block rooms to be able to more accurately reflect a realistic depiction of actual availability. In this example, the system, based on monitored booking behavior and historical booking activities, modifies, at run-time when the interface is rendered, the availability of open block rooms to twenty given a significant rise in booking behavior across the system or a historical pattern of unavailable bookings.

Data table 118 is configured to provide access to the augmented data structure to an attendee API 110. The attendee API 110 is configured to provide the augmented data structure associated with a request from an attendee 102 to a user device associated with an attendee 102. The attendee API 110 generates an augmented data structure representation which is parsed so that it can be displayed through corresponding interactive graphical control elements on the user device associated with the attendee 102. The augmented data structure representation that is displayed on the user device may include actionable selections which can be triggered through inputs on the interface of the user device. In some embodiments, the augmented data structure representation may be embedded with logic rules which determine how the inventory is displayed, whether contracted, open block, or both types of inventory are displayed at the same time, how long a specific open block inventory object is displayed, and when to update the open block inventory with new offerings. These logic rules may be generated and stored within a database 116 (e.g., a SQL database) which manages and controls the flow of data within the platform.

As a non-limiting example, the augmented data structure representation, according to the rules held within the database 116, may be configured to first present the contracted rooms to an attendee up until the point when all contracted bookings have been filled. At this point, open block inventory will be presented to the attendee within the same platform. To achieve this, the GDS 112 must pull real time open block inventory from the third party servers 114 and the data table 118 may expand or contract to reflect the changes in the open block inventory availability.

In some embodiments, the augmented data structure representation, according to the rules held within the database 116, is configured to present both a grouping of contracted inventory and a grouping of open block inventory to an attendee's user device display. The grouping of contracted inventory may be displayed as a primary booking option as the platform prioritizes filling contracted blocks, and the grouping of open block inventory may be displayed as a secondary booking option. In some embodiments, the contracted bookings may be available at a discount due to the bulk discount that was given at the time of purchase. In another embodiment, the contracted bookings may be price controlled to ensure that open block inventory does not undercut contracted inventory.

In some embodiments, price control may be achieved through a sourcing algorithm stored within the database 116. In some embodiments, the sourcing algorithm may comprise logical rules which exclude open block bookings that are offered at a lower cost than the contracted bookings. In some embodiments, the sourcing algorithm may comprise logical rules which match the contracted room to a lowest cost open block inventory object. In a further embodiment, the sourcing algorithm may comprise adjusting the price of open block inventory to match the price of contracted inventory available for an event.

In another example, the augmented data structure representation may be a hybrid data structure which incorporates a combination of contracted inventory and open block inventory into a single data structure. For example, an attendee may have submitted a request to book 4 nights at a specific hotel, however the contracted inventory is only available for 2 or 3 of those nights. Under traditional systems, the platform would return a “no availability” message to the attendee. However, under the proposed system 100 and 100A, the attendee API 110 may generate, through instructions from the database 116, a hybrid data structure which contains both contracted and open block inventory that satisfies the attendee's request. In some embodiments, the attendee API 110 is configured to prioritize generating hybrid data structures of contracted and open block inventory that share certain characteristics, such as same hotel, same room type, similar price, and the like.

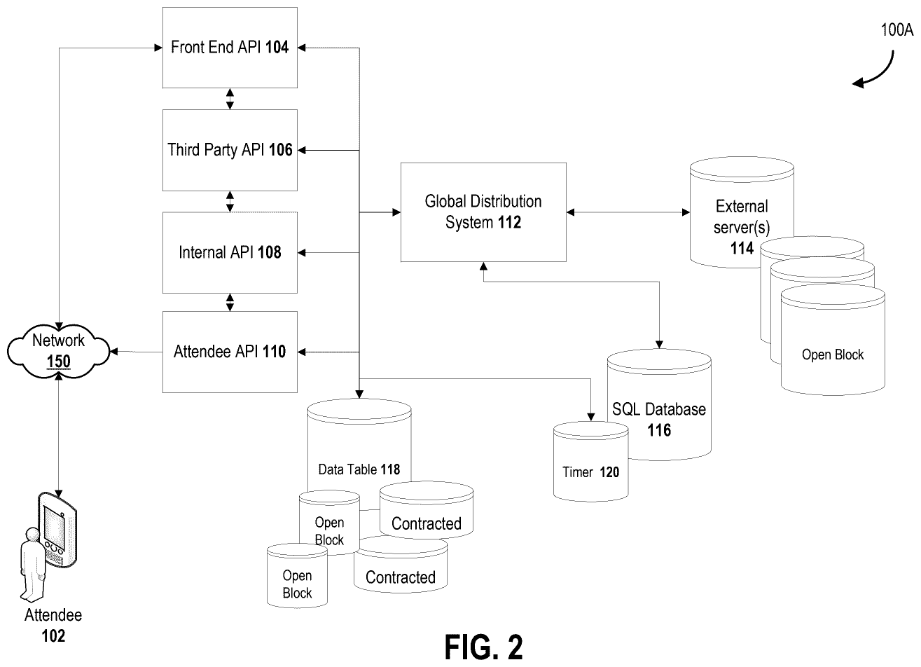

FIG. 2 is a block schematic diagram of an example system 100A for combining heterogenous data objects into an augmented data structure representation. The primary working principles of system 100A can be taken from the description above describing system 100. However, system 100A incorporates a further component, timer 120 which interoperates with the GDS 112 to extend hold times on open block inventory from the third party server 114.

In system 100A, an additional component, timer 120, may be incorporated into, or operate externally from, the SQL database 116. Timer 120 stores timing variables and is used to implement logical rules executed by a processor that control the timing and frequency of poll requests sent to the GDS 112 by the third party API 106. These poll requests are used by the GDS 112 to query the third party servers 114 for open block inventory availability. By controlling the timing of the pull requests, this may negate the risk that open block inventory becomes unavailable while a user request is still active.

In some embodiments, timer 120 may be configured to control the frequency and timing of poll requests based on an estimate generated by the GDS 112 of the hold time for open block inventory for specific third party servers 114, or based on an average for all third party servers 114 being queried.

In some embodiments, the third party API 106 may be instructed based on the timer 120 to send repeating queries on a timed schedule. The timed schedule being determined by the estimated hold time of the GDS 112 on the open block inventory. The repeating queries may include the GDS 112 requesting further information from the third party servers 114 or submitting identical requests to the third party servers 114.

In some embodiments, the third party API 106 may be configured to receive control instructions from the timer 120 to continuously query the GDS 112 with requests until the attendee booking has been completed. In some embodiments, the third party API 106 may begin continuously submitting poll requests to the GDS 112 once an attendee enters the checkout process to increase the likelihood that the open block inventory will remain available until the checkout is completed.

In a further embodiment, the third party API 106 may be configured to generate expected open block inventory availability and provide an estimate on whether certain queries will poll available open-block inventory. This may be used to identify when there is scarcity for a specific open block inventory grouping which may be used by timer 120 to adjust the timing and frequency of queries submitted through the GDS 112.

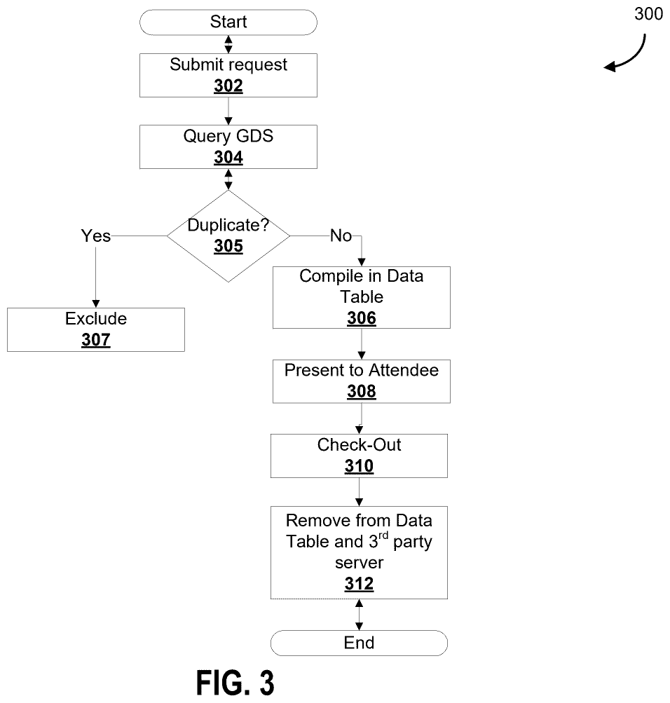

FIG. 3 is a data process diagram showing the data management rules stored within the SQL database 116 and implemented as a result of an attendee request, according to some embodiments.

Process 300 begins when an attendee submits a request 302 to book an accommodation within the platform. The request is handled by the front end API 106 and transferred to the third party API 106 where it is parsed to identify the embedded metadata within the request which will be used to structure the query communicated to the GDS 112.

The third party API 106 sends a query 304 to the GDS 112 which communicates with third party servers 114 to pull open block inventory availability into the GDS 112. The resulting open block inventory is stored within data table 116 alongside contracted inventory. As the GDS 112 may either be in communication with multiple third party servers 114, or be submitting multiple pull requests to the third party servers 114, this may result in duplicate open block inventory objects being pulled. As a result, the GDS 112 may identify duplicates 305 and exclude them from being compiled within the data table 116.

In some embodiments, GDS 112 may identify duplicates and determine whether the original or preceding duplicate should be excluded. This decision may be based on factors such as expected hold time, price, discounts, promotions, and the like.

If the open block inventory object is not excluded, then it will be compiled 306 into the data table 118 alongside the contracted inventory. The contracted inventory being retrieved by the internal API 108 and stored within the data table 118. The data table 118 will generate an augmented data structure which combines the open block and contracted inventory into a single storage format which can be presented to the attendee as a graphical user interface element rendered from the uniform data structure.

The data table 118 is accessed by the attendee API 110 and an augmented data structure representation is parsed such that it can be used to generate the inventory objects as actionable objects. The attendee API 110 communicates with a user device controlled by an attendee 102 and presents 308 the augmented data structure representation on a display within the user device.

The attendee 102 may be presented with an augmented data structure which displays both the contracted inventory and open block inventory on a single interface. In another embodiment, the interface may present only the contracted inventory so long as contracted inventory is available. In another embodiment, the interface may present open block inventory after a certain period of time has passed (i.e. based on when the booking contract will expire) or after a certain amount of contracted inventory has been filled. In a further embodiment, the interface may present the user with hybrid inventory options which are a combination of contracted inventory and open block inventory that can be booked in a single transaction.

The presentation provided to the attendee 102 by the interface displayed on their user device may be determined by logical conditions stored within the database 116. The logical conditions may be default rules which apply to all events, or may be a subset of rules stored on the database 116 which are specific to the event associated with the user request and determined by the administrator that initially made the booking contracted for the contracted inventory.

The attendee 102 may interact with the interface presented on their user device display to select an actionable object corresponding to an open block or contracted inventory object. This will result in a check out process 310 being initiated allowing the attendee 102 to reserve the inventory object without having to leave the platform.

Upon completion of the check out process 310, the attendee will receive confirmation that their reservation has been processed, the attendee API 110 will submit a request to the GDS 112 and data table 118 to confirm completion of the reservation and to remove the inventory from global inventory listing.

It may be understood that the system 100 or 100A may be interacting with a plurality of users at any one time. The plurality of users may have booking requests which overlap such that the same booking request may result in one or more of the same open block inventory objects being presented to multiple users. This could result in situations where double booking may occur through the platform. Therefore, once an attendee has selected an actionable object and is proceeding through checkout, the selected inventory object should be identified by the system and made unavailable for other attendees and within the GDS 112. This will ensure that multiple attendees can not modify the same data object simultaneously, which could result in corruption of the data structures within the GDS 112 and data table 118.

Without these protections, the system 100 and 100A may struggle to ensure data integrity when multiple users are attempting to modify data concurrently. This is especially important as concurrent access to inventory is inevitable when multiple attendees are looking to book from either the same listing of contracted inventory, or from the same listing of open block inventory stored within the data table 118.

Other approaches to avoid double booking involve table locking the inventory listing every time a user accesses an individual object within the table. This may be inefficient for open block inventory since table locking would require the system 100 or 100A to lock each room, data table and listing for every request. This may result in increased processing time and computing resources being needed, especially during high traffic periods.

In some embodiments, the system 100 and 100A may use an optimization algorithm which replaces the table locking function. The optimization algorithm may avoid the need for table locking by ensuring that when an attendee interacts with a data structure, through a checkout process for example, the interaction only impacts the augmented data structure object within the data table when the interaction is completed. If the interaction is not completed by the attendee, then the data object retains its original structure within the data table 118. Further, the optimization algorithm may only allow one attendee to interact with a data object within the data table 118 at any one time, thereby avoiding the need for table locking while still ensuring concurrent access from attendees to the data table 118.

In some embodiments, the optimization algorithm is used solely when an attendee interacts with an open block inventory object within the augmented data structure. In another embodiment, the optimization algorithm is used when an attendee interacts with both contracted and open block inventory within the augmented data structure.

In a further embodiment, in order to reduce computing resources and power needed when multiple attendees are concurrently accessing the platform and interacting with overlapping data structures, a caching algorithm may be stored and implemented by the SQL database 116 which utilizes multiple inventory sources to reduce the time required to pull open block inventory.

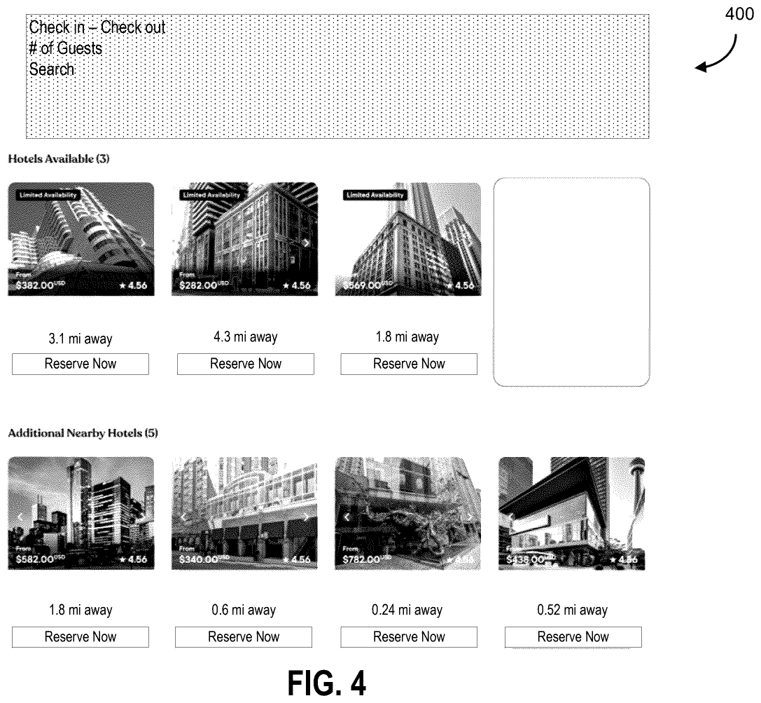

FIG. 4 is a user interface diagram on an output display 400 of a user device which displays an exemplar augmented data structure representation.

In output display 400, a user is presented with an interface which contains a search bar which can be used to input user requests and information which will be used to generate the metadata associated with their request. The user request will be associated with an event that is managed by an administrator. Each event will be further tied to a listing of contracted inventory within the platform.

Once a user request is input by the attendee, the front end API 104 and third party API 106 will begin the process of submitting a pull request to the GDS 112 to retrieve open block inventory from third party servers 114. The open block inventory is retrieved based on metadata embedded within the user request and from metadata associated with the event that the attendee is associated with. The metadata may be used by the third party API 106 and GDS 112 to pull open block inventory which is within a specific price range, within a specific geographic radius, contains contracted inventory associated with the event, has a minimum/maximum rating, has been approved by the administrator and the like.

The open block inventory is then stored within the data table 118. The contracted inventory associated with the user request is also compiled within the data table 118, which combines the heterogenous data structures of the open block and contracted inventory into an augmented data structure. The augmented data structures are then available to be accessed by a user or group of users who have overlapping or concurrent user requests.

The augmented data structures may be parsed by the attendee API 110 such that it is structured into a representation that can be displayed as an interface on a user device. The augmented data structure representation may include actionable inventory objects which allows an attendee to interact with the augmented data structure representation, with the outcome of the attendee interactions being a checkout process that will result in a data object within the augmented data structure being reserved and therefore removed from the data table 116 and GDS 112 listings.

The augmented data structure representation may allow contracted and open block inventory to be represented through a single interface in a manner that allows the attendee to interact with the same process and platform to reserve inventory regardless of whether it is contracted or open block.

The augmented data structure representation may be subject to logical rules stored within the database 116 which are applied to the representation by the attendee API 110. The logic rules may determine what objects within the augmented data structure are included in the representation on the user device. These logical rules may be determined by the system 100 and 100A, or may be specific to an event and thereby determined by an administrator.

In some embodiments, open block inventory is not included within the augmented data structure and therefore not stored within the data table 118 or included within the augmented data structure representation. Therefore, open block inventory would not be available for reservation by an attendee within the platform. Instead, the attendee would be presented only with contracted inventory availability within the platform. This may be useful under conditions such as during the initial days when the contracted inventory becomes available for booking (since there is a large amount of contracted inventory available that must be filled).

Under this embodiment, the database 116 is interrogated to identify when the amount of contracted inventory for a specific event is sufficiently filled, or completely filled, and begin introducing open block inventory into the augmented data structure representation. Since the open block inventory can be dynamically pulled from the GDS and stored within the data table 118, the open block inventory can be pulled only when it is needed or be subject to caching algorithms that reduce processing time.

In another embodiment, the augmented data structure representation may include a mixture of contracted inventory and open block inventory which can be reserved by the attendee. In this embodiment, represented by display 400, the augmented data structure representation may display the open block and contracted inventory in pre-determined orders, priorities or quantities. For example, contracted inventory may be displayed as a first option that is prioritized over open block inventory. This may be beneficial when an administrator is confident that they will fill their contracted inventory listing but still have contracted availability.

In some embodiments, such as if an attendee is looking to reserve inventory close to the date of the event, there may not be sufficient availability within the contracted inventory for the duration of their request. Therefore, the augmented data structure representation may provide hybrid inventory which combines contracted and open block inventory into a single data object within the interface.

For example, if an attendee is attempting to book reservations two days before a conference, there may be minimal or zero contracted inventory available. In this situation, the database 116 may contain data management instructions which, when applied to the data table 118, will result in the augmented data structure representation parsed from the data table 118 to include either only open block inventory or a combination of open block inventory and contracted inventory that could satisfy the attendee request.

This may result in an attendee having a 4 day booking which comprises two days of contracted inventory for a specific hotel or hotel room, and two days of open block inventory for the same hotel or hotel room; or 4 days of open block inventory.

The above hybrid inventory embodiment may also be beneficial when an attendee is seeking to request a booking which extends beyond the length of days that are covered by the contracted inventory (i.e. conference is from Friday-Sunday, attendee seeks to stay from Thursday-Monday).

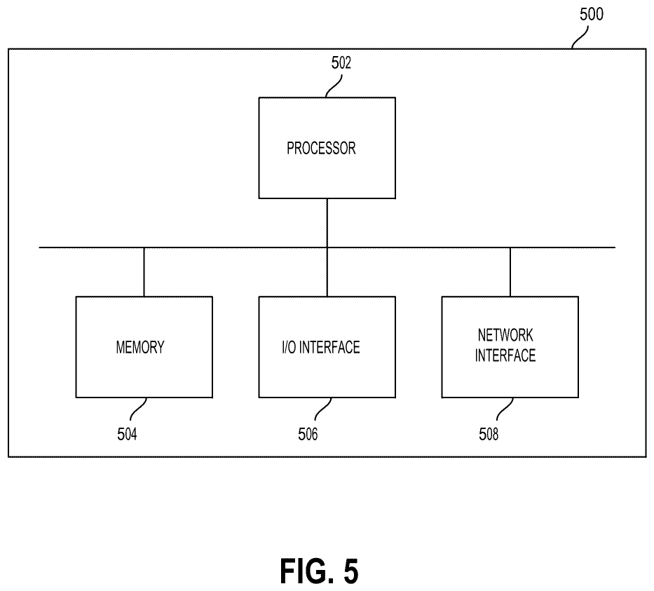

FIG. 5 is a schematic diagram of a computing device 500 such as a server which may implement the proposed system discussed above. As depicted, the computing device includes at least one processor 502, memory 504, at least one I/O interface 506, and at least one network interface 508.

Processor 502 may be an Intel or AMD x86 or x64, PowerPC, ARM processor, or the like. Memory 504 may include a suitable combination of computer memory that is located either internally or externally such as, for example, random-access memory (RAM), read-only memory (ROM), compact disc read-only memory (CDROM).

Each I/O interface 506 enables computing device 500 to interconnect with one or more input devices, such as a keyboard, mouse, camera, touch screen and a microphone, or with one or more output devices such as a display screen and a speaker.

Each network interface 508 enables computing device 500 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others.

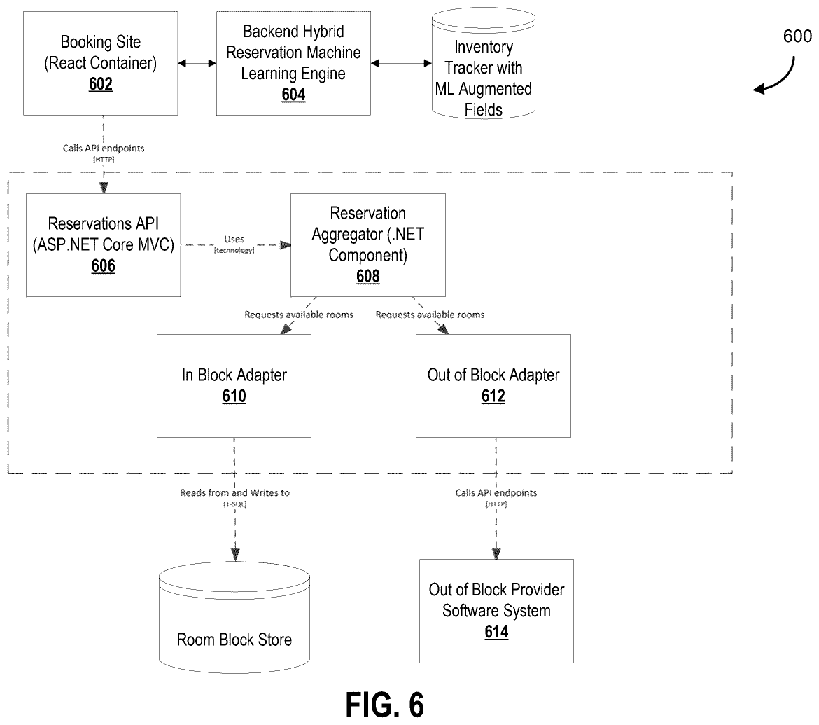

FIG. 6 is a block schematic diagram 600 of an example system architecture for combining in block (contracted inventory) and out of block inventory and corresponding adapters, according to some embodiments.

As shown in diagram 600, a booking site 602 is hosted in a React container that provides a single page application that users can connect to in order to book rooms. The booking site 602 is configured to render a graphical user interface that is rendered on a computing device of a user, and the graphical user interface provides a booking mechanism where the user can use an input mechanism, such as a touch screen or a combination of keyboard and mouse inputs to indicate a selection for a query or to request a booking.

The booking site 602 is coupled to the backend hybrid reservation machine learning engine 604 that is used to render the visual elements of a booking page that combines both available open block and contracted block inventory availability in accordance with the backend inventory tracker with machine-learning augmented data fields. The booking site 602 is also coupled to a reservations API 606 that is an API endpoint that is used for booking rooms.

When a reservation is made, the reservation aggregator engine 608, which can be a. NET component) is configured to aggregate reservations from multiple sources, and spawns child room request data messages that are sent to an in block adapter 610 and an out of block adapter 612, both of which can be. NET components. The in block adapter 610 may allocate internal reservations by updating an internal booking data structure room block store, which can be a data record in a SQL database to allocate contracted inventory. The out of block adapter 612 is a wrapper that is utilized in conjunction with APIs provided by out of block provider(s), which allows the reservation aggregator engine 608 to transmit messages to a plurality of provider computer systems 614 each associated with different out of block providers to make reservations. The provider computer systems 614 are hotel computer interfaces for reservation management.

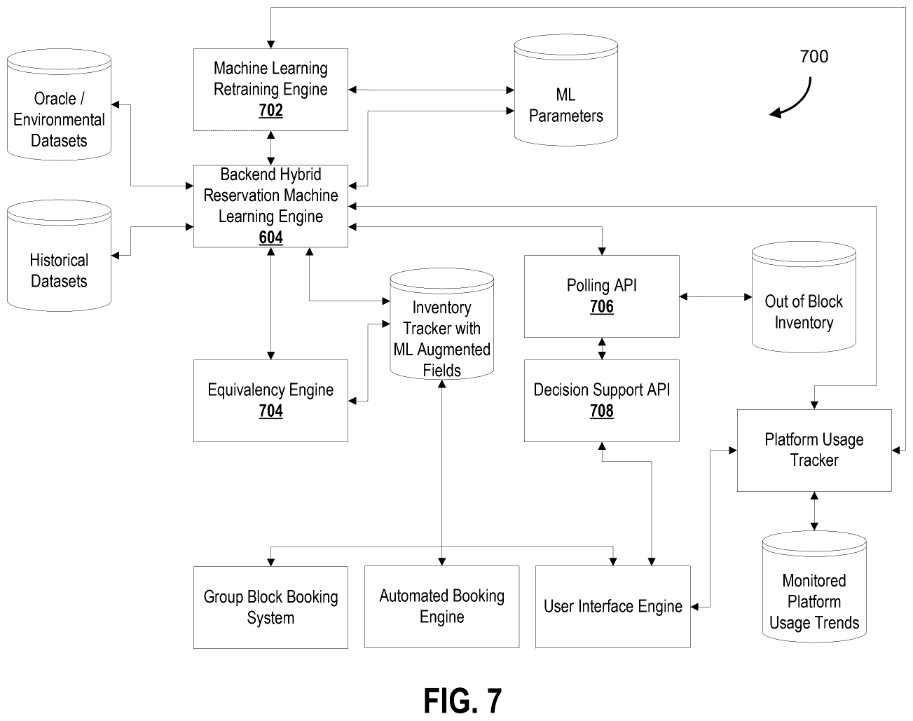

FIG. 7 is a computing diagram that illustrates, in greater detail, the backend hybrid reservation machine learning engine 604, according to some embodiments.

The backend hybrid reservation machine learning engine 604 is coupled to a machine learning model data architecture maintaining machine learning parameters, which can be instantiated prior to usage at default values or with random values. The machine learning model data architecture represents trainable parameters which represent weights and interconnections of one or more hidden layers of interconnected computing nodes (that represent interconnected artificial neurons). The weights and interconnections are used in combination with activation functions to, in aggregate, generate a logit output based on a provided input, the logit output.

The weights and interconnections are iteratively updated through a supervised training phase where the backend hybrid reservation machine learning engine 604 iterates through labelled training data to update the parameters to minimize a loss function.

An example loss function can include minimizing the sum of squared errors relative to a successful chance of booking at a particular desired price point given the location, characteristics, and temporally proximate characteristics associated with a point in time, such as number of events taking place, what date/time of year, among others.

The backend hybrid reservation machine learning engine 604 is configured to access datasets representing historical events, corresponding historical inventories, as well as time-stamped historical data and usage data, which can include platform usage history, such as tracked mouse clicks, page traversals, among others. As new inputs are obtained, these can also be used to periodically retrain the machine learning parameters using machine learning retraining engine 702. In some embodiments, the historical data sets indicative of platform usage are temporally proximate to the time, and the level of platform usage can be measured through a proxy such as a number of tracked search interactions / queries in the associated area, or a number of other booking parties and their activities on the same platform.

Upon being satisfactorily trained, which can include the backend hybrid reservation machine learning engine 604 reaching a pre-defined threshold of accuracy in respect of a test dataset, the backend hybrid reservation machine learning engine 604 can be deployed for usage, and can receive periodically event information of events currently in the pipeline and their estimated attendance, currently available inventories and the current sales uptake (how inventories for the required days has decreased recently), historical seasonal trends and world events.

This information can be received in the form of input datasets that can be mapped to specific input nodes of an input layer of the backend hybrid reservation machine learning engine 604, along with specific open block inventory (e.g., “out of block” inventory) objects and their corresponding characteristics. Each open block inventory object represents a potentially available open block reservation, at a particular characteristic and price. Each open block inventory object is augmented with additional data fields by the backend hybrid reservation machine learning engine 604 through operation of the backend hybrid reservation machine learning engine 604 in an inference mode using the trained machine learning model data architecture.

For example, a received set of open block inventory objects may include the following:
Hotel X for CES in Las Vegas area, Jan. 6-Jan. 9, 2026, Hotel Room 1, Non-Smoking, City View, 4.5 Stars, within 0.5 miles of the main event location, average of $255 per night, king bed, 4 rooms available.
Hotel Y for CES in Las Vegas area, Jan. 6-Jan. 7, 2026, Hotel Room 2, Smoking, Garden View, 3 Stars, within 1.5 miles of the main event location, average of $200 per night, king bed, 10 rooms available.
Hotel Y for CES in Las Vegas area, Jan. 6-Jan. 7, 2026, Hotel Room 4, Smoking, Garden View, 3 Stars, within 1.5 miles of the main event location, average of $400 per night, suite room with two queen beds and a sofa bed, 15 rooms available.

The above information can be returned on a periodic polling query along with a timestamped value of when the information was accurate. However, as noted above, a danger of showing external inventory inline with contracted inventory is that the external inventory can have a level of entropy and unpredictability due to fluctuations in pricing and available, especially as other parties may be racing to make the same bookings, or similar bookings may impact availability and if the hotel uses demand based dynamic pricing, may impact pricing as well. For an event such as CES, there are many organizations and many events taking place across the city, and room demand and availability is constantly fluctuating. On the other hand, for a less popular event in a less crowded city, room demand and availability may be more consistent. From an inventory perspective, it is helpful to be able to indicate such demand trends, but deterministic approaches can be difficult to establish computationally given the non-linear relationships between supply and demand, and environmental characteristics.

Accordingly, the data structure is expanded with additional machine learning metadata fields that correspond to estimated price adjustment factors as well as estimated availability adjustment factors, and these price adjustment factors and estimated availability factors can be associated with a time-decay value such that the values are automatically adjusted based on a staleness from the timestamp from when the query result was obtained.

The machine learning engine returns a τ_{price} and a τ_{availability} value that is used to adjust prices and to represent a decay of availability at τ_{price}, respectively. These values are appended to the generated record corresponding to the Hotel Room 1, Room 2, and Room 4 as noted above, such that the time period that has elapsed between the polling of the external provider API and the generating of the interface can be used as an input to generate, from the additional τ_{price} and a τ_{availability} values to estimate the adjusted price and availability at run-time. As the inputs into the machine learning engine include characteristics of the proposed reservations as well as locations, the times and dates, the generated outputs can be established on a per room type basis, providing a greater level of granularity. For example, in an event such as CES, larger rooms may be more popular due to the need for exhibitors to be able to prepare in their rooms, and some exhibitors use their rooms for meetings. On the other hand, other events may have a greater trend of popularity for single person rooms, for example.

From a machine learning perspective, the inputs are vectorized and provided into input nodes of the machine learning model and used for inference. The trained machine learning model has output notes corresponding to a price adjustment logit and an availability adjustment logit, which are then normalized and appended into the data structure for downstream use during run-time operation.

If the estimated price is outside of a pre-defined threshold range or the likelihood of availability significantly decayed, the user interface can adjust down the available inventory to reflect a further constrained inventory. For example, if there are originally 50 rooms each, but the machine learning model logits indicate that this is a scenario of high demand and high volatility where there is significant staleness in the polled quotes, it may constrain the showing at run-time to only 5 rooms available each to help ensure that the view provided to the user is more realistic.

The additional data fields that are generated include time-based fields indicative of estimated price stability within a threshold range, as well as expected availability based on a time decay factor from the poll request data load that loaded the open block inventory object, based on timer values obtained from operating timer 120. For example, the additional data fields can include the estimated modified price, based on the estimated price stability that is different than the quoted price (to automatically take into account pricing drift), as well as a probability of availability at the estimated modified price at a particular time. The additional fields can be generated at interface run-time by the backend hybrid reservation machine learning engine 604 whenever the booking site 602 is accessed to conduct a search of available inventory. At run-time, the time elapsed is then utilized as a factor to further the impact of potential stale inventory, and the generated time variables can be used as a proxy measurement for a velocity of price changes or inventory shrinking.

When the booking site 602 is accessed to conduct a search of available inventory, available contracted block inventory is shown in addition/graphically “in line” with open/out of block inventory that is identified by the equivalency engine 704. The equivalency engine 704 is a computing process that identifies similar block inventory to contracted block options within a pre-defined range of prices and characteristics, such as distance, amenities, and rating, even if the existing contracted block options are already booked and no longer available.

The equivalency engine 704 is configured to limit a number of specific open/out of block inventory data objects based on an availability time decay metric that is adjusted automatically by the backend hybrid reservation machine learning engine 604 operating in the inference mode. For example, while the out of block adapter 612, when polled by polling API 706 may show an availability of seventy five rooms of room type A being available at a price of two hundred dollars a night, the system may automatically apply an adjustment factor based on booking/search velocity on the platform, new events being introduced into the platform, or previous booking error messages that may adjust the expected room availability down to fifty rooms instead.

The output results are then provided as data messages for decision support API 708 which is coupled with the booking site 602 to provide the constrained set of data objects for available for reservation by the user on the booking site 602. The equivalency engine 704 is a computing process that is configured to identify similar booking availability having similar characteristics within a range of acceptability, as there may not always be a perfect analog to a contracted room type.

Accordingly, the system is configured to automatically tailor and constrain the set of results such that a more realistic depiction of available inventory is presented that is generated on a run-time basis and based on time-decay metrics from a last inventory pull or push from a polled system. A time period is provided to the user to attempt to initiate reservation requests through the reservation aggregator engine 608, which is an automated engine for automatically allocating reservation requests between reservations being made against the available in block reservations at 610, or to be made externally through the out of block adapter 612. The reservation aggregator engine 608 is configured with different logical rules for allocations as between the available in block reservations and open block external reservations. In some embodiments, the reservation aggregator engine 608 is configured to prioritize available in block reservations as these reservations may have floor booking requirements to be met. However, different configurations are possible, such as time-duration based prioritizations where for a first duration of time, the reservation aggregator engine 608 prioritizes allocating towards open block reservations to strategically maintain availability of the contracted block reservations (especially if an event is expected to be very popular and availability is expected to be constrained), and then at a second duration of time, prioritize allocating towards contracted block inventory so that the entire contracted block inventory will be used up to avoid unbooked contracted inventory. Other variations are possible.

In a further embodiment, the reservation aggregator engine 608 is further configured to automatically book reservations autonomously from the out of block adapter 612 in view of expected bookings, and the booked reservations can be automatically triggered when, for example, time decay availability logits generated by the backend hybrid reservation machine learning engine 604 are greater than a pre-defined threshold indicative of rapidly dwindling inventory. The automatically booked reservations can include refundable reservations or held reservations as determined by the equivalency engine 704 as being sufficiently similar to those of the contracted inventory options, and the automatically booked reservations can be added to a reserve of contracted “in block” inventory and allocated by the reservation aggregator engine 608. By automatically generating the booked reservations, the system can be configured to automatically attempt to lock in preferential pricing to support expected over-demand by users of the platform. In some embodiments, the reservation aggregator engine 608 is configured to automatically prioritize the pre-emptive reservations for new bookings, and to re-allocate or cancel holds or reservations as required if there is outstanding availability in the original contracted “in block” after a duration of time while the holds or reservations are still refundable or partially refundable.

Accordingly, the proposed system and method is configured to support a platform which allows an attendee 102 to book a trip within a single interface that contains contracted and open block inventory, and in some embodiments, the inventory data objects are dynamically rendered and their characteristics are automatically modified based on machine learning-based augmented fields to show a computer estimated realistic view of the combination of inventory, where the entropy and unpredictability of pricing and availability of external open block inventory is automatically taken into consideration. Accordingly, event administrators are able to gain access to dynamic inventory which can respond to the needs of their event attendees. As a result, attendees who may have migrated to a third party server to complete their reservation will be captured under the proposed system and method. Not only will this increase the commission which flows through the platform to the event administrator, but will also provide a richer breadth of attendee metadata which can be used to improve the user experience of the user and future users who are characterized by the same user characteristics.

The increased amount of user engagement captured by the proposed system and method may also result in generating a more complete picture of the economic metric and impact that an event has on a local economy. Event administrators can leverage these improved metrics to pitch their events to hosting cities, and negotiating better incentives from a potential hosting city.

Lastly, the system and method may provide more efficient computer representation and interactions of the heterogenous inventory. This may result in decreased processing power and storage being required to operate the system and method within the platform owners internal architecture.

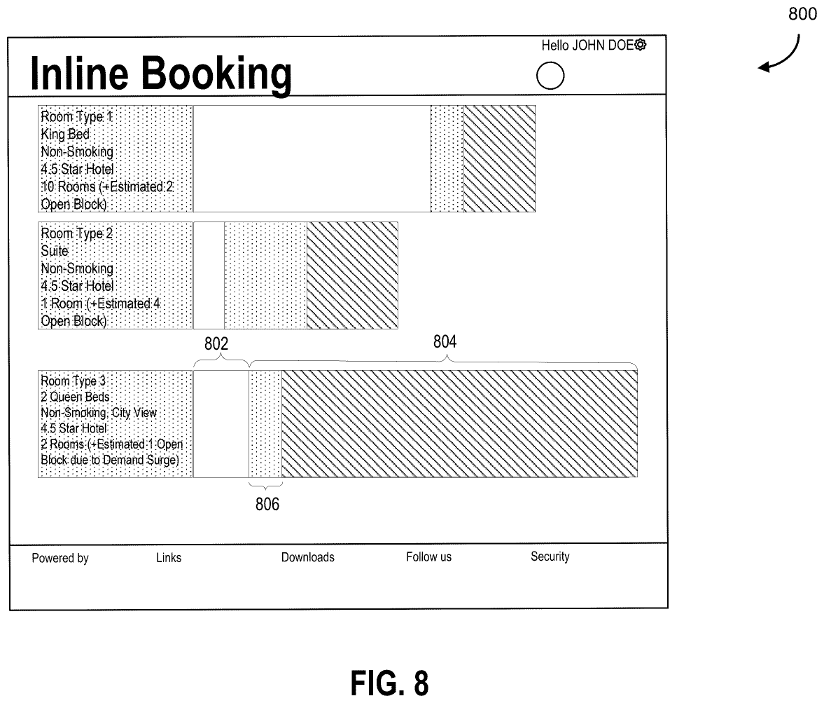

FIG. 8 is an example interface showing a dynamically generated decision support interface 800 with intermingled contracted block and open block inventory interactive graphical data objects, according to some embodiments.

As shown in FIG. 8, the dynamically generated decision support interface 800 is dynamically generated at run-time when the user accesses the website booking page. In this example, room availability is shown in respect of a Room Type 1, Room Type 2, and Room Type 3. A non-limiting example of the interactive graphical interface elements are shown, and the user may select a particular room type for booking through interacting with the graphical elements (e.g., by clicking on the desired room type and indicating a total number of rooms to be reserved). The contracted inventory is shown graphically using the bars. As shown in the example interface 800, a first bar 802 is shown indicative of the availability of contracted, “in block” inventory, and this is extended through a depiction of the total available “out of block” inventory through external providers that are coupled to the system at 804. As the total available “out of block” inventory may not be indicative of a realistic view of actually available “out of block” inventory, the amount shown in bar 804 is modified and adjusted automatically to establish bar 806, which indicates the constrained section of 804 that is estimated to be sufficiently within the original price range and estimated to be available for booking as time-adjusted based on when the last poll of the “out of block” inventory was and corresponding machine learning logits through operation of the machine learning model in inference. The bar 806 is determined through interrogating the inventory tracker that has been augmented with machine learning based fields that are used to determine the adjustment factors.

As shown in the example for 800, while for each of the three room types, there is some level of open block availability, the adjusted constrained block inventory representing an improved estimate is less than the full availability. The example for Room Type 3 is provided to show an example where there is high demand or a potential surge as estimated by the system, and this is reflected through a significant decay logit that is in the augmented field that was automatically generated by the system. While for Room Type 3 a naïve poll of the API indicates a large number of rooms, in this example, the system automatically adjusts the view to show that it expects only 2 rooms to be available with a proximate price range due to increased booking entropy that is automatically captured through the machine learning model being operated at run-time when the interface is generated.

This automatic adjustment mechanism is particularly useful in situations where a more accurate view is helpful, such as for conference bookings where there are multiple organizations and/or multiple events taking place in a city or a region, and their booking and reservation activity causing downstream effects on availability. Potential attendees would benefit from an interface that not only displays the contracted availability that their organization or organizer has available, but also potentially extended availability of external providers. However, the extended availability has a level of price and/or availability unpredictability, and this is automatically captured and indicated through operation of the machine learning model in inference to provide a useful updated booking interface tool.

When a user interacts with the interface 800 to make a booking either of the contracted inventory or the out of block inventory, the system is configured to record whether the user was able to successfully book, and the price that the user was required to pay, and these recordations are used to establish a retraining data set that are used as a supervised learning training set to periodically re-train and update the weights using the machine learning retraining engine 702. The retraining data set further includes temporally proximate environmental context variables, in some embodiments.

In a variant embodiment, the reservation aggregator engine 608 is configured to pre-emptively replenish contracted block inventory by automatically generating pre-emptive bookings and holds when inventory of the contracted block has begun to diminish below a pre-defined threshold number of availability (e.g., below 2 rooms).

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A dynamic graphical user interface rendering system for rendering a graphical user interface combining contracted reservation inventory and open block reservation inventory, the system including one or more processors and one or more memories coupled with the one or more processors, the one or more processors configured to:
maintain a trained machine learning model data architecture trained using iterative supervised training using an input data set to estimate time-based shifts in pricing and availability;
periodically receive, from one or more external reservation management computing systems, time-stamped data sets indicative of availability characteristics at a first point in time corresponding to externally available reservation data objects;
operate the trained machine learning model architecture in an inference mode to determine at least a time-based price adjustment value and a time-based availability adjustment value;
record the time-based price adjustment value and the time-based availability adjustment value in an extended data structure having records corresponding to each type of available reservation;
receive a request to render the dynamic graphical user interface at a second point in time to determine inventory related to one or more contracted reservation object types;
determine, at least using the extended data structure, one or more adjusted availability values within a pre-defined adjusted price range for each of the one or more contracted reservation object types from the externally available reservation data objects; and
render, on the dynamic graphical user interface, one or more graphical interface elements indicative of a total availability of the one or more contracted reservation object types and a constrained set of externally available reservation data objects, constrained based on the one or more adjusted availability values.

2. The dynamic graphical user interface rendering system of claim 1, wherein the one or more processors are configured to automatically generate reservation data messages to generate reservations from the constrained set of externally available reservation data objects if the one or more contracted reservation object types has availability values below a pre-defined threshold.

3. The dynamic graphical user interface rendering system of claim 1, wherein operation of the trained machine learning model data architecture in the inference mode includes providing a data set indicative of aggregated temporally proximate dynamic graphical user interface rendering system inputs across a corpus of user accounts as an input into the trained machine learning model data architecture for generating the time-based price adjustment value and the time-based availability adjustment value.

4. The dynamic graphical user interface rendering system of claim 3, wherein the data set indicative of aggregated temporally proximate dynamic graphical user interface rendering system inputs across a corpus of user accounts is utilized to determine a demand surge velocity value that is provided as an additional input for generating the time-based price adjustment value and the time-based availability adjustment value.

5. The dynamic graphical user interface rendering system of claim 1, wherein the one or more graphical interface elements include at least a first graphical representation of an availability of one or more contracted reservation object types, and a second graphical representation of the constrained set of externally available reservation data objects.

6. The dynamic graphical user interface rendering system of claim 4, wherein the one or more graphical interface elements include at least a third graphical representation of the externally available reservation data objects.

7. The dynamic graphical user interface rendering system of claim 5, wherein the second graphical representation is overlaid over the third graphical representation.

8. The dynamic graphical user interface rendering system of claim 1, wherein the extended data structure is updated periodically through periodic polling of the one or more external reservation management computing systems.

9. The dynamic graphical user interface rendering system of claim 8, wherein the time-stamped data sets are time-stamped based on when the datasets are received from the one or more external reservation management computing systems.

10. The dynamic graphical user interface rendering system of claim 1, wherein the one or more processors reside in a computer server operating in a data center, the computer server configured to host a web services platform rendering the graphical user interface.

11. A dynamic graphical user interface rendering method for rendering a graphical user interface combining contracted reservation inventory and open block reservation inventory, the method comprising:
maintaining a trained machine learning model data architecture trained using iterative supervised training using an input data set to estimate time-based shifts in pricing and availability;
periodically receiving, from one or more external reservation management computing systems, time-stamped data sets indicative of availability characteristics at a first point in time corresponding to externally available reservation data objects;
operating the trained machine learning model architecture in an inference mode to determine at least a time-based price adjustment value and a time-based availability adjustment value;
recording the time-based price adjustment value and the time-based availability adjustment value in an extended data structure having records corresponding to each type of available reservation;
receiving a request to render the dynamic graphical user interface at a second point in time to determine inventory related to one or more contracted reservation object types;
determining, at least using the extended data structure, one or more adjusted availability values within a pre-defined adjusted price range for each of the one or more contracted reservation object types from the externally available reservation data objects; and
rendering, on the dynamic graphical user interface, one or more graphical interface elements indicative of a total availability of the one or more contracted reservation object types and a constrained set of externally available reservation data objects, constrained based on the one or more adjusted availability values.

12. The dynamic graphical user interface rendering method of claim 11, wherein comprising automatically generating reservation data messages to generate reservations from the constrained set of externally available reservation data objects if the one or more contracted reservation object types has availability values below a pre-defined threshold.

13. The dynamic graphical user interface rendering method of claim 11, wherein operation of the trained machine learning model data architecture in the inference mode includes providing a data set indicative of aggregated temporally proximate dynamic graphical user interface rendering system inputs across a corpus of user accounts as an input into the trained machine learning model data architecture for generating the time-based price adjustment value and the time-based availability adjustment value.

14. The dynamic graphical user interface rendering method of claim 13, wherein the data set indicative of aggregated temporally proximate dynamic graphical user interface rendering system inputs across a corpus of user accounts is utilized to determine a demand surge velocity value that is provided as an additional input for generating the time-based price adjustment value and the time-based availability adjustment value.

15. The dynamic graphical user interface rendering method of claim 11, wherein the one or more graphical interface elements include at least a first graphical representation of an availability of one or more contracted reservation object types, and a second graphical representation of the constrained set of externally available reservation data objects.

16. The dynamic graphical user interface rendering method of claim 14, wherein the one or more graphical interface elements include at least a third graphical representation of the externally available reservation data objects.

17. The dynamic graphical user interface rendering method of claim 15, wherein the second graphical representation is overlaid over the third graphical representation.

18. The dynamic graphical user interface rendering method of claim 11, wherein the extended data structure is updated periodically through periodic polling of the one or more external reservation management computing systems.

19. The dynamic graphical user interface rendering method of claim 18, wherein the time-stamped data sets are time-stamped based on when the datasets are received from the one or more external reservation management computing systems.

20. A non-transitory computer readable medium storing machine interpretable instructions, which when executed by a processor, performs a dynamic graphical user interface rendering method for rendering a graphical user interface combining contracted reservation inventory and open block reservation inventory, the method comprising:
maintaining a trained machine learning model data architecture trained using iterative supervised training using an input data set to estimate time-based shifts in pricing and availability;
periodically receiving, from one or more external reservation management computing systems, time-stamped data sets indicative of availability characteristics at a first point in time corresponding to externally available reservation data objects;
operating the trained machine learning model architecture in an inference mode to determine at least a time-based price adjustment value and a time-based availability adjustment value;
recording the time-based price adjustment value and the time-based availability adjustment value in an extended data structure having records corresponding to each type of available reservation;
receiving a request to render the dynamic graphical user interface at a second point in time to determine inventory related to one or more contracted reservation object types;
determining, at least using the extended data structure, one or more adjusted availability values within a pre-defined adjusted price range for each of the one or more contracted reservation object types from the externally available reservation data objects; and
rendering, on the dynamic graphical user interface, one or more graphical interface elements indicative of a total availability of the one or more contracted reservation object types and a constrained set of externally available reservation data objects, constrained based on the one or more adjusted availability values.
